(19) United States
(12) Patent Application Publication
(10) Pub. No.: US 2007/0129101 A1
(43) Pub. Date: Jun. 7, 2007

(54) Telecommunication notebook computer

(75) Inventors: Ming-Chang Wang, Taipei (TW); Wen-Hsiung Chang, Taipei (TW); Chad-Cheng Linwu, Taipei (TW); Yi-Cih Wu, Taipei (TW)

Correspondence Address: BACON & THOMAS, PLLC, 625 SLATERS LANE, FOURTH FLOOR, ALEXANDRIA, VA, 22314, US

(73) Assignee: CLEVO CO., TAIPEI (TW)

(21) Appl. No.: 11/607,913

(22) Filed: Dec. 4, 2006

(30) Foreign Application Priority Data
Dec. 2, 2005 (TW) 94142537

(51) Int. Cl. H04M 1/00

(52) U.S. Cl. 455/550.1

(57) ABSTRACT

A telecommunication notebook computer functions as a mobile communication apparuatus and a notebook computer with both monitors. There is a mobile communication module configured in the computer system, which electrically configured to the system chipset, I/O system, built-in controller and other devices via the associated bus. The telecommunication notebook computer utilizes a secondary monitor to display a telecommunication frame to achieve the functionality of mobile communication. The functionality displayed on the secondary monitor provides various data including incoming caller information, short messaging alert, email alert, call receiving, voice dialing, virtual keyboard dialing, incoming/outgoing call history and plurality of mobile phone functionality.

### FIELD OF THE INVENTION

The invention provides a notebook computer with the functionality of mobile communication and its operational method, which uses the secondary monitor and the mobile communication module to achieve the objective of mobile communication.

### BACKGROUND OF THE INVENTION

The ease of mobility of the notebook computer resulted the mushroomed of its applications. The U.S. Pat. No. 6,532,146 revealed the configuration of the other monitors at the two sides of a notebook computer. Also, the U.S. Pat. No. 6,757,036 revealed the structure of the dual-monitor notebook computer, which produces the various extensions of its functionalities.

Because of the mobility of the notebook computer, the related art combined the notebook computer and the mobile communication device, such as the computer mobile communication system revealed by the U.S. Pat. No. 6,370,376, “Compurter Cellular Communication System”, which configured a cellular communication module with the function of signal reception and signal transmission on the computer motherboard. FIG. 1 illustrates the diagram of the cellular communication module, which comprised of a cellular communication processor 11, coupling to a primary modem 15, and a secondary modem 17. The cellular communication processor 11 also connects to the central processing unit (CPU) of the computer system. The primary modem 15 processes the input audio signals received by the receiver 19 via audio signal terminal 16, and processes the output audio signal transmitted by the transmitter 18 via audio signal terminal 16. The primary modem 15 produces audio signals and transmits the information such as the telephone number, account number stored in the memory card 13 during telecommunication, and also couples to the audio signal terminal 16 of the computer I/O port via the secondary modem 17.

The application of the mobile communication appling in a notebook computer, such as the U.S. Pat. No. 6,859,358, reveals the integration of wireless phone and notebook computer for the purpose of convenient utilization by a bigger monitor and keyboard in a notebook computer. The U.S. Publication No. US2003/0023761 reveals the configuration of a wireless communication module 20 and a notebook computer system 2 as illustrated in FIG. 2. The wireless communication module is coupling to the I/O system 26 via Universal Serial Bus (USB), and coupling the apparatus of the computer system via various bus in order to key in commands via keyboard controller 25, supply power to the module 20 via the source 27, and processed audio signal transmissions via the configuration of CPU 21, the system chipset 22 and the memory 23.

In today's market, there are many computers and personal digital assistant (PDA) provides the mobile communication method by integrating the wireless communication module, such as installing mobile phone module, Skype, Net2Phone and other communication software. The U.S. Publication No. US2005/0090238 reveals the utilization of wireless network communication module in PDA to achieve the goal of mobile communication.

With regards of the complex operational process when using the mobile communication techniques executed by the computer system in related art, current invention provides a secondary monitor in a computer system for fast and convenient in use of the mobile communication method.

### SUMMARY OF THE INVENTION

A telecommunication notebook computer with the functionality of mobile communication and its operational method utilizes a secondary monitor configured on the notebook computer and the mobile communication module, such as GSM module, to enable the function of mobile communication via I/O system of the computer system. The apparatus of this telecommunication notebook computer configures a secondary monitor controller module, a built-in processor to couple to the I/O system in the computer system, a mobile communication module and the audio signal processing technique to processe the audio transmission and reception.

The telecommunication notebook computer utilizes the mobile communication module on the computer system with primary and secondary monitor, to produce the communication functionality via a mobile communication module. The operational method of the telecommunication notebook computer is sending the enabling signal to the computer system when the mobile communication module receives the electromagnetic signal,and then the enabling signal is transmitted to system chipset of the computer system by a microprocessor to startup the associated audio apparatus and the secondary monitor for the operation of audio signal receiving, capturing, processing and transmitting.

The steps to establish the communication is startup the audio signal input apparatus at the beginning, and producing an enabling signal to startup the associated audio apparatus and the secondary monitor. After the connection, the audio signal is captured, processed by the mobile communication module, and then transmitted to the mobile communication module for output via a microprocessor.

### BRIEF DESCRIPTION OF THE DRAWINGS

FIG. 1 and FIG. 2 illustrate the embodiment of the prior art.

FIG. 3A-3D illustrate the embodiment of the operational method in accordance with the present invention.

FIG. 4 illustrates the computer system architecture of the embodiment in accordance with the present invention.

FIG. 5 illustrates the communication functionality architecture of the embodiment in accordance with the present invention.

FIG. 6 illustrates the operation flow chart of the communication functionality in accordance with the present invention.

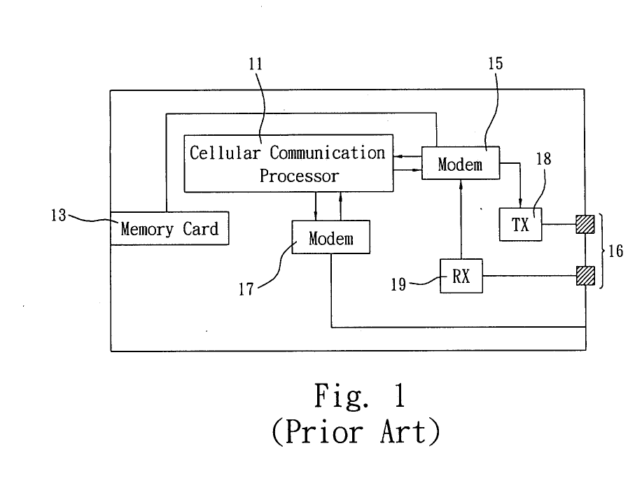

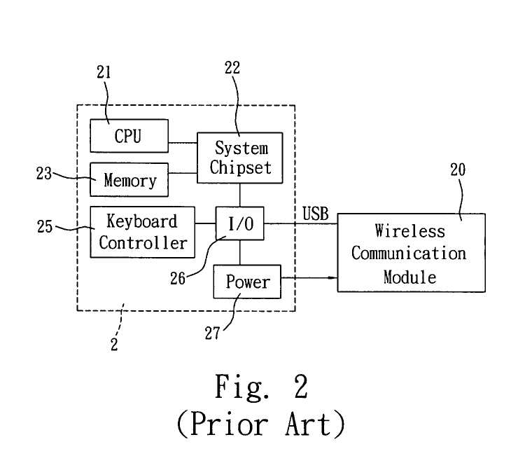

### DESCRIPTION OF THE PREFERRED EMBODIMENTS

The telecommunication notebook computer is a two-monitor notebook computer with mobile communication functionality. The preferred embodiment configures plurality of colored, grey scaled or monochrome display monitors in the computer system, and utilizes built-in or external mobile communication module cooperating the I/O port of the computer system to produce the functionality of the mobile phone, such as the incoming call display, short messaging alert, email alert, call receiving, voice dialing, virtual keyboard dialing and call history.

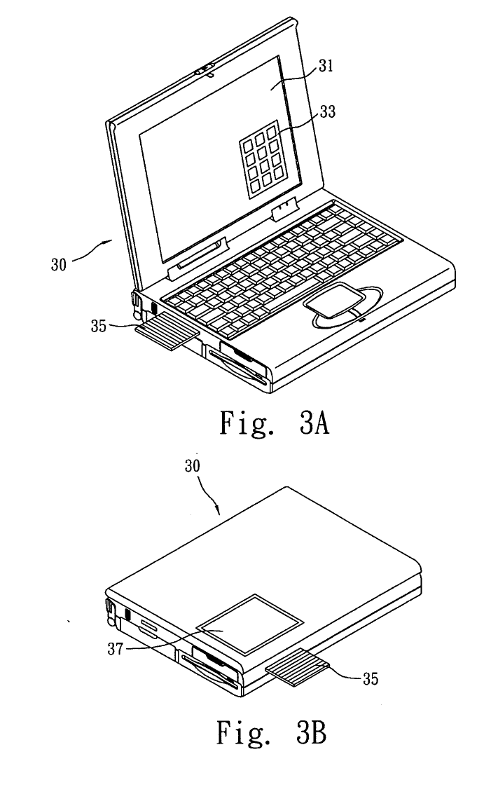

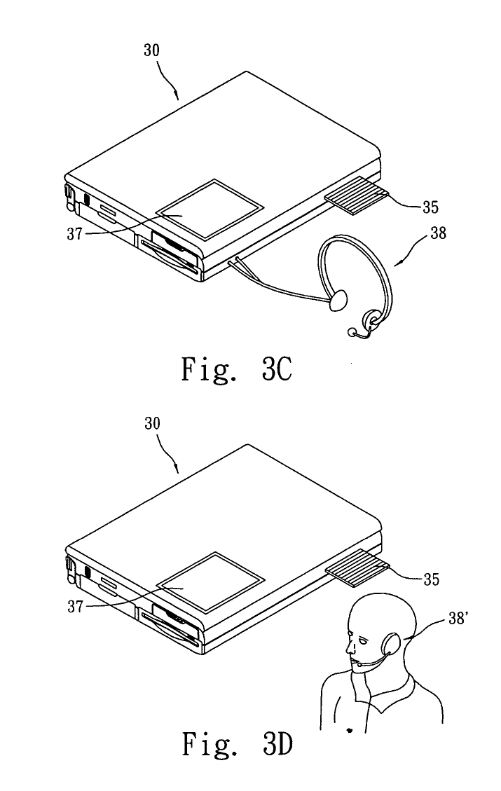

FIG. 3A illustrates the telecommunication notebook computer 30 of a preferred embodiment. The mobile communication module 35 is configured to the notebook computer 30 externally via USB, IEEE1394, PCMCIA or other interfaces. The primary monitor 31 of the computer system is used as the display screen of the mobile communication functionality, such as executing number dialing and call receiving functionality via virtual keyboard 33. If the above mobile communication module uses the Subscriber Identity Module (SIM) card of the mobile phone module, such as the GSM communication module, or the WiFi module of internet phone, then, the mobile communication module is also capable of being operated in the future communication environment. The number dialing operation not only can be executed by pressing the virtual keyboard, it can also be executed by voice dialing or by clicking the keyboard on the notebook.

FIG. 3B illustrates another of the preferred embodiment of current invention, herein the notebook computer 30 is equipped with dual monitor to achieve the mobile communication function. The figure shows a notebook computer with the lid closed. A secondary monitor 37 is configured on top of the lid in smaller size, lower resolution and contrast. However, the secondary monitor can be the same quality as the primary monitor. When the lid of the notebook computer closes down, normally the computer system is in shutdown/halt, or sleep mode. When the external (or built-in) mobile communication module 35 is in startup mode, the computer system still needs to standby for mobile communication, such as standby to maintain the processing of audio signal I/O system; drives the display module of secondary monitor 37, such as the display card, so that it can be wakeup anytime; and also supplies minimum power to the mobile communication module in standby mode.

The above secondary monitor 37 also displays the graphical information of various operation of mobile communication, in this embodiment, including the controlling screen of various communication, incoming caller information, video conference, and the graphical operational interface in communication.

FIG. 3C illustrates the mobile communication module 35 on duty, the user can use earphone, microphone and other audio signal apparatus 38 in communication. FIG. 3D illustrates how the user uses wireless earphone, microphone and other audio signal apparatus 38′ in communication, for instance, the Bluetooth apparatus.

The audio signal apparatus 38 cooperates the associated I/O system to provide voice controlling functionality. The user can preset or define various voice controlling functionality, such as voice dialing by saying the phone numbers; or voice dialing by saying the intended person's name to dial the matching numbers or to response, hang up for a call, and other communication functionality by using voice. Besides, the mobile communication module of the preferred embodiments illustrated above is configured to the notebook computer 30 externally, another embodiment can be achieved by built-in module.

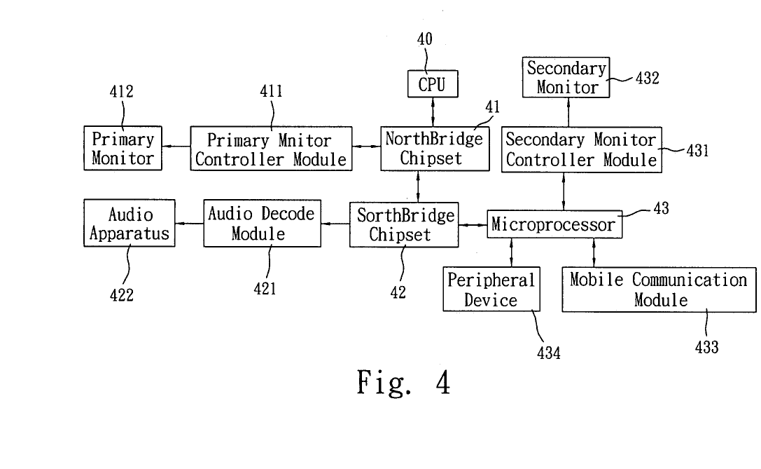

FIG. 4 illustrates the computer system architecture of the embodiment in accordance with present invention, which equipped with a primary and secondary monitor. Herein the computer system includes a built-in secondary monitor controller module 431, a mobile communication module 433, wireless earphone/microphone module (such as Bluetooth earphone, which is not illustrated in the figure), and a microprocessor 43 coupling to the SouthBridge chipset 42. The mobile communication module 433, wireless earphone and microphone module, and microprocessor 43 start operating when the secondary monitor controller module 431 is being powered up. The secondary monitor controller module 431 is coupling to the microprocessor 43 to display the telecommunication screen of the mobile communication, and to display the incoming call information and so on. The user is also capable of communicating by using wireless earphone and microphone module, or enabling the voice dialing functionality.

The mobile communication apparatus is configured to a computer system with primary and secondary monitor, utilizing the I/O system of the computer apparatus of this embodiment to achieve mobile communication.

For more detailed as illustrated in FIG. 4, the computer system comprises a CPU 40 coupling to the NorthBridge chipset 41, the SouthBridge chipset 42 and other system chipset. The NorthBridge chipset 41 is coupled to system memory (not illustrated in the figure) and a primary monitor controller module 411 which the video signal is transmitted and output by the primary monitor 412. SouthBridge chipset 42 is coupled to the peripheral apparatus, such as the audio codec module 421 and audio signal apparatus 422, where the audio signal is then output from the speaker or earphone via amplifier. A microprocessor 43 is also being coupled to the SouthBridge chipset 42, and the microprocessor 43 of the embodiment can be the built-in processor of the keyboard controller. The microprocessor 43 is also being coupled to the internal or external mobile communication module 433 in present invention. The mobile communication module 433 transmits the I/O signals of the audio signal reception and transmission via microprocessor 43. By means of the electrical connection of CPU 40 and SouthBridge 42, CPU 40 processes the signals and allocates resources to execute operations, such as displaying the communication information to the secondary monitor 432 and decoding the audio signal output from the audio signal apparatus 422. Furthermore, the audio codec module 421 comprises a wireless module, which executes the wireless signal transmission functionality, such as Bluetooth earphone or other associated peripherals, for more convenient telecommunication.

In the above architecture, the communication functionality is also available if the computer system is in normal operating mode (with the lid opened). The mobile communication module 433 is being coupled to the bus of SouthBridge chipset 42 via microprocessor 43, and sending the information to the SouthBridge chipset 42 by utilizing the application software. The signal is then processed by CPU 40, and sent to the primary monitor 412 via NorthBridge chipset 41 and the primary monitor controller module 411.

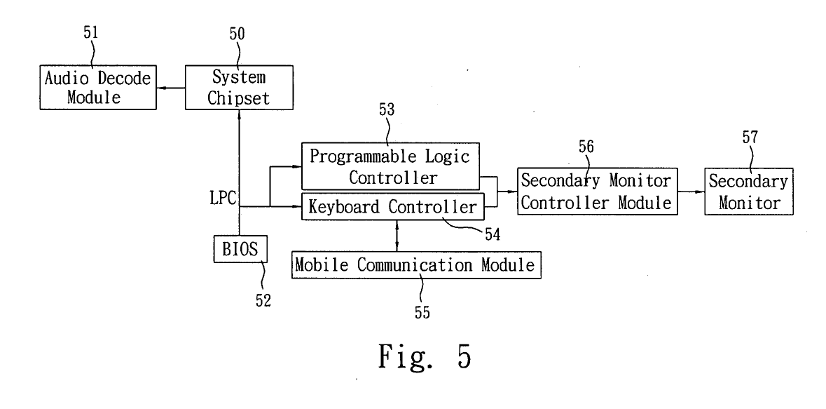

FIG. 5 illustrates the architecture of the telecommunication notebook computer equipped with the mobile communication module in normal startup mode ( including standby or shutdown mode) of the embodiment in accordance to present invention. The architecture at least includes a system chipset 50 coupling to the audio codec module 51 for audio output, and providing audio input/output functionality via Basic Input/Output System (BIOS) 52 of the computer system. BIOS 52 is also coupled to the keyboard controller 54 and the programmable logic controller 53 which is such as the Field Programmable Gate Array (FPGA) or Complex Programmable Logic Device (CPLD). The BIOS 52 couples to the keyboard controller 54 and programmable logic controller 53 via Low-Pin-Count (LPC) bus. The BIOS 52 also electrically couples to the secondary monitor controller module 56 via keyboard controller 54 and programmable logic controller 53 to process the controller signal together with the keyboard controller 54. The telecommunication screen providing to the user for telecommunication functionality control is displayed on the secondary monitor 57, which is coupling to the monitor controller module 56. A mobile communication module 55 is configured to the Keyboard controller 54, which the mobile communication module 55 can be built-in or externally configured to the computer system, and being used to operate the mobile communication. Furthermore, there are other voice input operations, such as the functionalities of voice dialing and voice controlling, executed via wired or wireless earphone and microphone module (not illustrated in the figure).

The operation flow of the telecommunication functionality produced by the telecommunication notebook computer with primary and secondary monitors processes as below:
1. When the notebook computer is being shut down, the communication information is provided to the user by displaying on the secondary monitor via the keyboard controller and the secondary monitor controller module. The user can dial out by the method of utilizing the voice dialing or clicking the virtual keyboard displaying on the secondary monitor.
2. When the notebook computer turns on but not executes the operating system yet, the primary monitor can be shutdown, but the functionality of telecommunication can be operated still by utilizing the secondary monitor displaying the telecommunication screen including the necessary information or the virtual keyboard for voice dialing.
3. In the operating system mode, the telecommunication functionlity can be executed by the software application installed in the operating system, such as startup the dialing functionality via virtual keyboard, startup the voice dialing and so on.

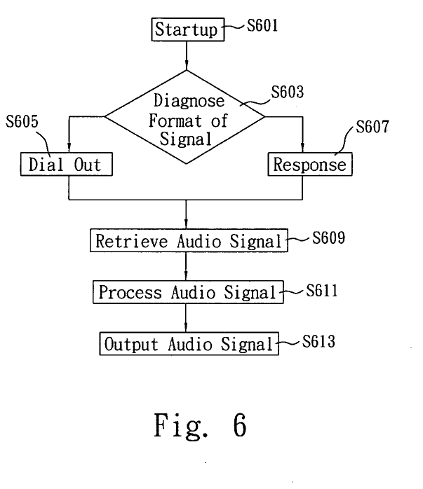

FIG. 6 illustrates the operation flow chart of the embodiment in accordance with the present invention. A mobile communication module is configured on the telecommunication notebook computer with primary and secondary monitors to process the telecommunication functionality. When a telecommunication signal is being received, the mobile communication module processes the telecommunication functionality by cooperating the associated resources of the computer system.

In the beginning, the associated apparatus for telecommunication is in standby mode. At this time, the notebook computer system can be in operating mode or shutdown mode. The mobile communication operating steps begin when the mobile communication module receives an electromagnetic signal or an enabling signal (S601) produced by the user's dialing manually. In the above startup, the secondary monitor displays the telecommunication screen for users to control which functionality will be executed. After the mobile communication module receives the enabling signal, the microprocessor diagnoses the format of the enabling signal (S603), such as by checking the flag and the header of the enabling signal, to determine the object of the enabling signal. During the step of diagnosing the format of the enabling signal, the secondary monitor is displaying the related information of the telecommunication signal, such as sound alert stored in database, for users to determine answering the phone or not. The database stores the information, such as the sound alert, including incoming call alert, notification graphic, and other control icon.

After the enabling signal is determined to be an outgoing call signal, the associated module such as the system chipset, audio codec module, BIOS, keyboard controller, FPGA and CPLD as illustrated in FIG. 5 are functioning to dial out (S605). The operation of dialing out (S605) is executed to input/output voice by the mobile communication module cooperating to other peripheral. The input/output voice is transmitted by the function of the audio codec module, which is controlled by operating voice dialing, a virtual keyboard, or the real keyboard of the notebook computer. On the other hand, if the format of the enabling signal is determined to response (S607), the associated functional module will be also functioning to execute the voice input/output operation.

After determining the operation to response or dial out, the associated audio apparatus is driven by the system chipset. The enabling signal is received by the microprocessor, then the secondary monitor is activated by the secondary monitor controller module. The telecommunication functionality is operated by voice control via wired/wireless earphone and microphone, or by controlling hardware/software. The audio signal is then retrieved (S609) by the mobile communication module via the system chipset. Then, the audio signal is being processed (S611) by the audio decode module. The audio signal is decoded to its original signal at receiving, on the contrary, the audio signal is encoded at transmitting. Next, the audio signal after processed is transmitting to the computer system via microprocessor, and outputting to an audio output apparatus (S613) after decoded by the audio codec apparatus via system chipset.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. A telecommunication notebook computer, controlling an I/O system to drive a mobile communication module in a notebook computer to achieve the mobile communication, said telecommunication notebook computer comprising:
a microprocessor, being a built-in processor;
said mobile communication module, being electrically coupled to said microprocessor;
a system chipset, coupling to said microprocessor;
a CPU, coupling to said system chipset;
a monitor controller module, coupling to said system chipset and a monitor displaying the telecommunication screen; and
a audio codec module, coupling to said system chipset and a audio signal apparatus to input/output audio signal.

2. The telecommunication notebook computer as set forth in claim 1, wherein said system chipset is a NorthBridge chipset and a SouthBridge chipset.

3. The telecommunication notebook computer as set forth in claim 1, wherein said monitor controller module is a primary monitor controller module to couple to a primary monitor.

4. The notebook computer with mobile communication as set forth in claim 3, wherein said primary monitor displays the telecommunication screen controlled by said primary monitor controller module.

5. The telecommunication notebook computer as set forth in claim 1, comprising a secondary monitor controller module coupling to said microprocessor and a secondary monitor.

6. The telecommunication notebook computer as set forth in claim 5, wherein said secondary monitor displays the telecommunication screen controlled by said secondary monitor controller module.

7. The telecommunication notebook computer as set forth in claim 1, wherein said audio codec module comprises a wireless module utilizing to execute telecommunication functionality.

8. The telecommunication notebook computer as set forth in claim 1, wherein said microprocessor is a keyboard controller.

9. A telecommunication notebook computer, being installed a computer system, comprising:
a mobile communication module, being utilized to execute mobile communication operation;
a microprocessor, coupling to said mobile communication module;
a system chipset, coupling to said microprocessor to receive communication signal;
a BIOS, coupling to said system chipset and said microprocessor so as to provides I/O functionality for said computer system;
an audio codec module, coupling to said system chipset to process audio signal;
a secondary monitor controller module, coupling to said microprocessor to receive communication signal; and
a secondary monitor, coupling to said secondary monitor controller module to display telecommunication screen.

10. The telecommunication notebook computer as set forth in claim 9, wherein said microprocessor is a keyboard controller and a programmable logic controller to cooperatively process wireless communication signal.

11. The telecommunication notebook computer as set forth in claim 9, wherein a mobile communication apparatus is coupling to said secondary monitor displaying the telecommunication screen to execute telecommunication functionality.

12. The telecommunication notebook computer as set forth in claim 9, wherein said secondary monitor is configured on top of the lid of said telecommunication notebook computer.

13. A method of a telecommunication notebook computer, by means of utilizing a mobile communication module coupling to a notebook computer with primary and secondary monitors to process telecommunication functionality, wherein the means comprise the steps of:
startup;
diagnosing the format of audio signal, determining outgoing call or receiving call in according to the format of said audio signal via said mobile communication module;
retrieving audio signal by a system chipset after diagnosing the format of said audio signal;
processing audio signal by an audio codec module after retrieving said audio signal by said system chipset;
outputting audio signal processed by said audio codec module to an audio output apparatus to play said audio signal.

14. The method of the telecommunication notebook computer as set forth in claim 13, wherein the step of startup is achieved by displaying the telecommunication frame on a secondary monitor to execute the communication functionality.

15. The method of the telecommunication notebook computer as set forth in claim 14, wherein the step of diagnosing said format of signal is achieved by displaying the information of said audio signal on said secondary monitor.

16. The method of the telecommunication notebook computer as set forth in claim 15, wherein said information of said audio signal displaying on said secondary monitor comprises incoming call alert, notification graphic, and control icon.

17. The method of the telecommunication notebook computer as set forth in claim 13, wherein when the determination said format of said audio signal is dial out, the operation is achieved by utilizing the voice dialing mode via said audio codec module, pressing the numbers of a virtual keyboard displayed on said secondary monitor, or clicking the keyboard of said notebook computer for number dialing.
